(19) United States
(12) Patent Application Publication
(10) Pub. No.: US 2004/0237332 A1
(43) Pub. Date: Dec. 2, 2004

(54) Cooling machine for lollipops

(75) Inventors: Seferinus Jelle Asma, Veldhoven (NL); Leonardus Hermanus Maria Cuypers, Ell (NL)

Correspondence Address: LADAS & PARRY, 26 WEST 61ST STREET, NEW YORK, NY, 10023, US

(73) Assignee: CFS WEERT B.V.

(21) Appl. No.: 10/741,153

(22) Filed: Dec. 19, 2003

Related U.S. Application Data
(63) Continuation of application No. PCT/NL02/00423, filed on Jun. 25, 2002.

(30) Foreign Application Priority Data
Jun. 25, 2001 (NL) NL 1018380
Jun. 25, 2002 (NL) NL02/00423

(51) Int. Cl. F26B 19/00; F26B 25/00

(52) U.S. Cl. 34/236

(57) ABSTRACT

Cooling machine for lollipops, comprising at least one support plate having a support surface for supporting lollipops during cooling, means for generating a cooling air flow past the support surface and means for shaking the support surface, the plate being a honeycomb panel having a honeycomb core and an upper cover plate, the core being made of metal and the cover plates being fixedly adhered to the core and the upper cover plate forming the support surface directly or not.

The invention relates to a cooling machine for lollipops.

In a possible production form lollipops are collected after manufacturing prior to being packaged at a later moment. The lollipops have to be cooled down after forming as they would otherwise stick to each other and deform. In case of round lollipops, such as lollipops having a spherical shape or a kind of cylindrical shape, it should be prevented that the lollipops—that are still soft after forming—are flattened on one side because they lie still and deform under the influence of their own weight. It is attempted to prevent this by reciprocally moving the support surface on which the lollipops are cooled with cooling air, for instance with a frequency of 150/min. This shaking, as a result of which the lollipops roll to and fro, costs a lot of power.

It is desired for the power-demanding cooling process, to cool large numbers of lollipops, as a result of which an as large as possible support surface (long and wide) is wanted. However, this has the drawback that the (heavier) support plate may sag, as a result of which the lollipops will tend to move towards each other and to the centre, and stick together and deform.

Another drawback is that the weight of the support plate becomes larger, as a result of which more power is necessary for shaking, and a heavy—expensive—drive is needed.

It is an object of the invention to at least improve on some of these points. From one aspect the invention to that end provides a cooling machine for lollipops, comprising at least one support plate having a support surface for supporting lollipops during cooling, means for generating a cooling air flow past the support surface and means for shaking the support surface, the plate being a honeycomb panel having a honeycomb core and an upper cover plate and a lower cover plate, the core being made of metal and the cover plates being fixedly adhered to the core and the upper cover plate forming the support surface directly or not.

Such a support plate is rigid and will in case of larger spans not sag or very slightly so, so that also in case of large spans a truly flat support surface is offered and the lollipops will not tend to move to a lowered area to cluster there and deform. Such a support plate may moreover be lightweight.

Preferably the core and the cover plates are made of aluminium, as a result of which a very rigid structure is obtained, which is very lightweight and as a result can be shaken with very little power.

Preferably the upper cover plate is coated with a layer of resilient synthetic material having a water repellent, cleansing means resistant closed surface, with sufficient friction with respect to the lollipop, so that the reciprocally moving coating brings the lollipop in motion and it cannot remain lying still. Preferably the layer is adhered over its entire surface to the upper cover plate.

In a further development of the cooling machine according to invention it comprises a supply for the lollipops and a discharge for the lollipops and a number of support plates positioned in between them inclined from the supply to the discharge, the support plates being inclined in opposite directions. Thus a kind of vertical zig-zag track is provided for the lollipops, forming a long cooling path that needs little room in horizontal direction. In case of an odd number of support plates the discharge can be situated at the side of the cooling machine that is opposite the supply, as a result of which the supply and the discharge do not hinder each other.

Preferably the shaking means are adapted for shaking consecutive support plates simultaneously in a regular out-of-phase manner, and preferably in transverse direction to the inclination of the support plate in question, so that the force directions are distributed and imbalance is prevented as much as possible.

The cooling means preferably comprise cooling air flow generators, positioned in a cooling air circuit in which the support surfaces are included in longitudinal direction, so that cooling air is urged over the lollipops, past at least almost the entire cooling path, enabling the air flow conditions over the support plates to be constant to a high degree. In known cooling machines the circulating cooling air is urged in vertical sense, near the discharge end, over the support plates, and then propelled up again in the discharge end. In the areas of the support plates situated more at a distance from the discharge end, the circulation of cooling air is less intensive, and as a result the efficiency is lower.

Preferably the cooling air circuit comprises the supply end, the discharge end and a horizontal return channel which is situated above over the upper support plate, a separation plate being arranged in between the return channel and the upper support plate. Thus the cooling air circuit circulates in a vertical plane, and the space at the top of the cooling machine is used for the return flow, as a result of which the width of the cooling machine can remain limited.

Preferably the cooling means comprise propelling means, particularly fans, that are placed at the supply end.

In an advantageous manner the propelling means can be placed at the top and convert the flow of the air from a vertical direction into a horizontal direction.

When the supply is narrower than the support plate consecutive to it, the cooling air can easily flow past it in the circulation.

It may occur that grit is present on the support plates, for instance from the thin layer-like protrusions and from residues of a previous cooling step, for instance with lollipops of a different colour. The older the machine with which the lollipops are made is, the more thin layer-like protrusions there will be on the lollipops. When changing to another colour there is the risk that the lollipops will have colour residues of the previous process step on them.

To solve this problem the invention from a different aspect provides a lollipop cooling machine with inclined, vibrated, conveying support plates, baffles being arranged at the lower end of each inclined support plate at either side of the lower or discharge end thereof, which baffles are provided with slits situated parallel to the support surface, the height of the slits being smaller than the thickness of the sticks of the lollipops. Thus grit is discharged, but lollipops cannot get stuck in the slits. The slit passage will not get clogged up.

Preferably the baffles are slanting with respect to the direction of inclination, considered in top view, as a result of which the interception of grit is improved. Grit reception means behind the slits in the baffles facilitate the discharge thereof.

The invention will now be elucidated on the basis of an exemplary embodiment shown in the attached drawings, in which:

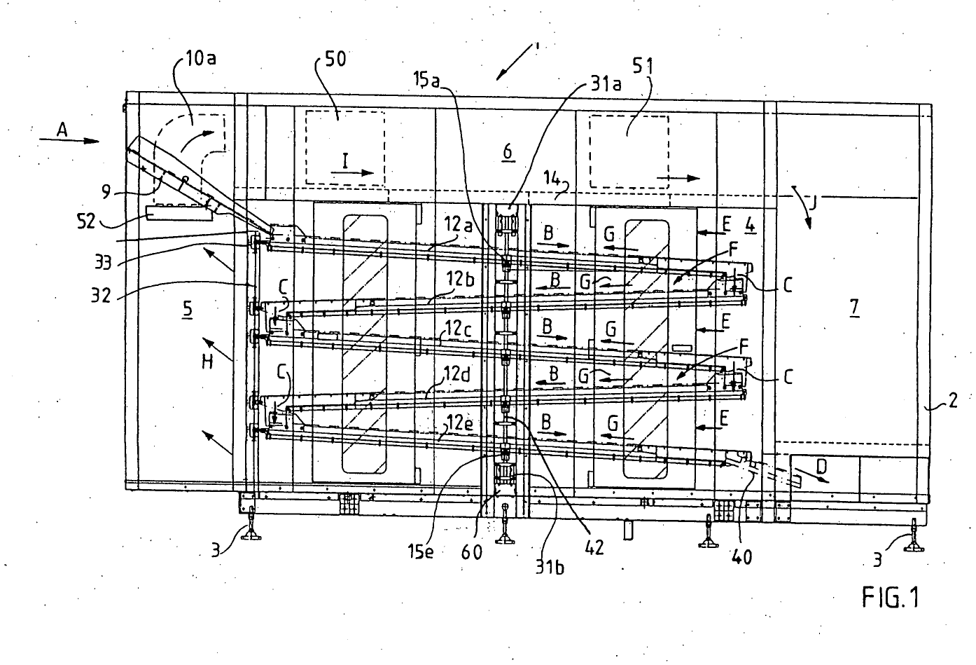

FIG. 1 shows a side view of an example of a cooling device according to the invention;

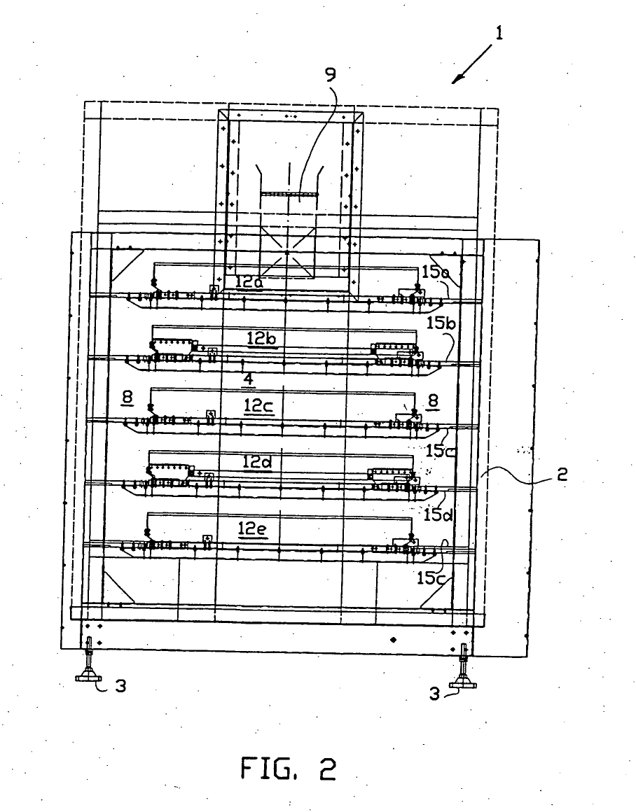

FIG. 2 shows an end view of the cooling device of FIG. 1;

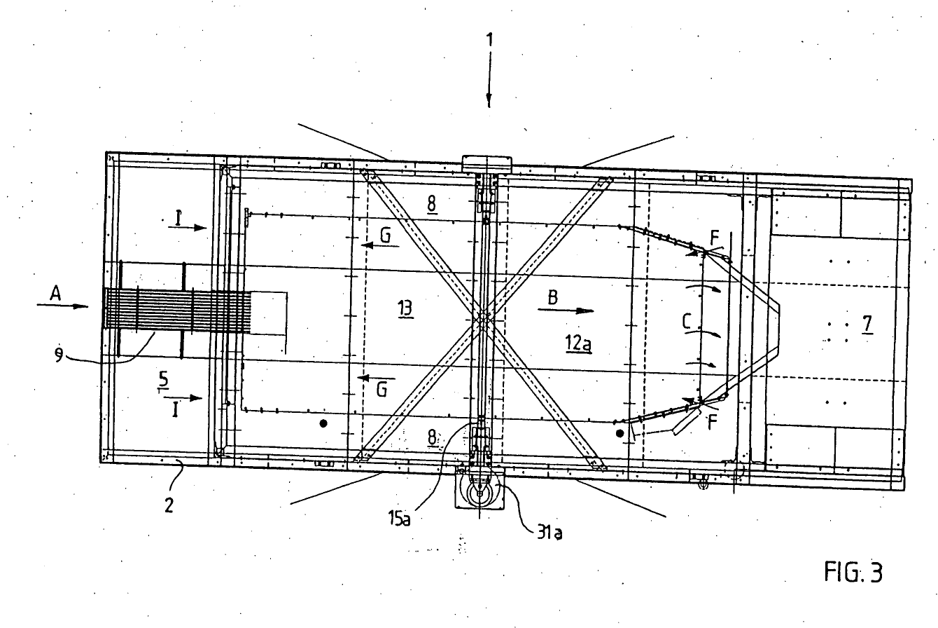

FIG. 3 shows a schematic top view of the cooling device of the FIGS. 1 and 2;

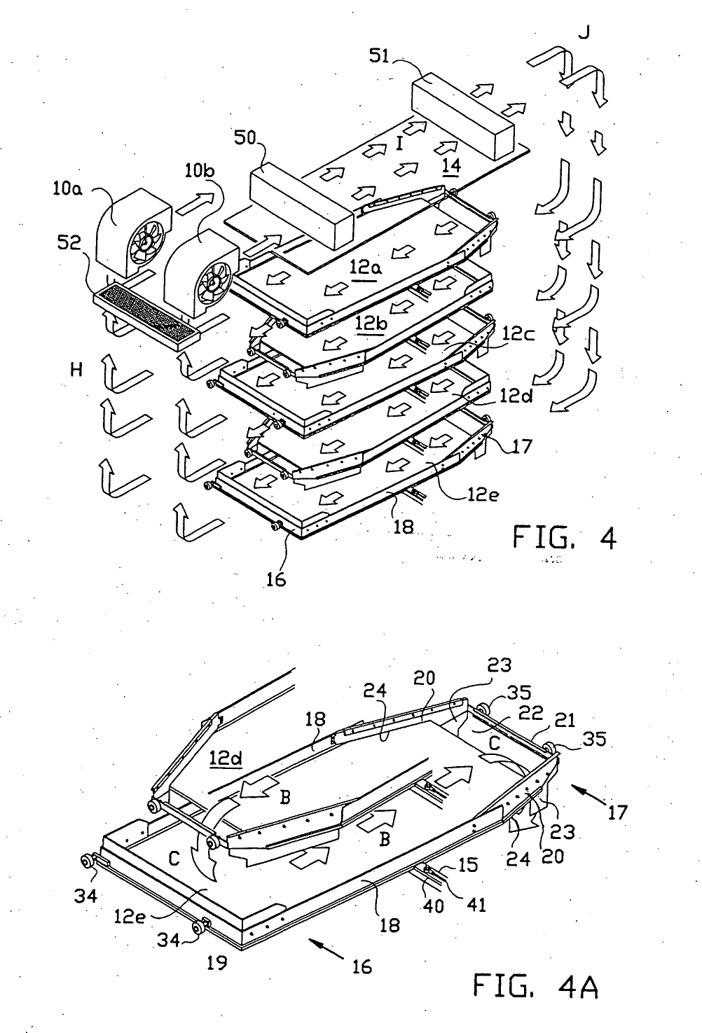

FIG. 4 shows a number of parts of the cooling device of the FIGS. 1-3 in schematic, exploded view;

FIGS. 4A and 4B show some details of the support plates of the cooling device of the preceding figures; and

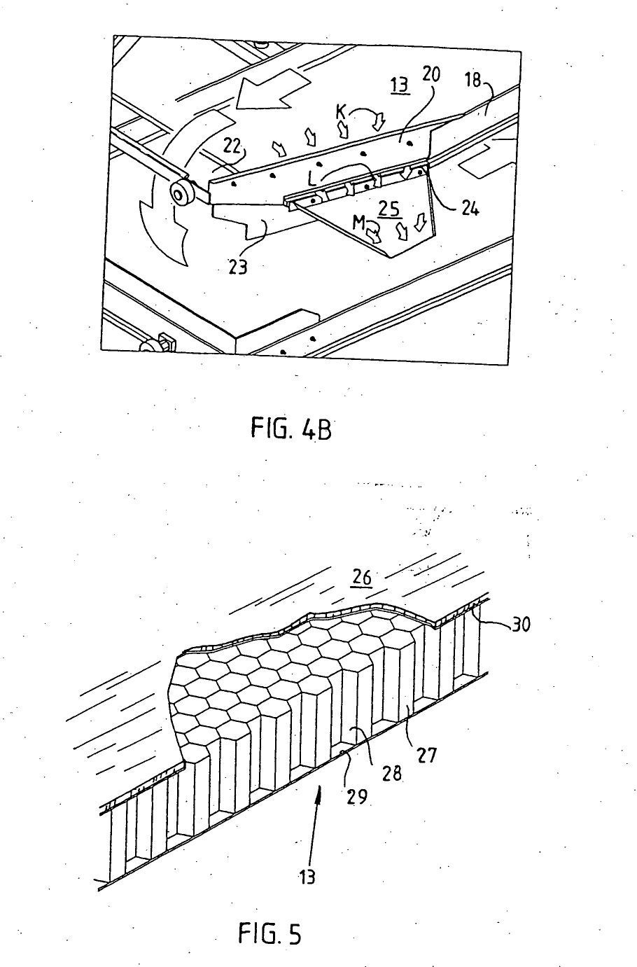

FIG. 5 shows a detail of the build-up of the said support plate.

The cooling device 1 in FIGS. 1-3 comprises a frame 2 placed on a basis with adjustable legs 3. The frame 2 is insulated and plated to the outside and the top, so that an insulated casing is formed. Within the plating can be discerned an inner space 4, and end space 5, an upper space 6, and end space 7, as well as side spaces 8 (see FIGS. 2 and 3). The spaces 4 and 6 are separated from each other by means of upper plate 14, but the spaces 4 and 7 and 4 and 5 are in open connection with each other.

At the top in the end 5 a supply chute 9 is positioned, along which lollipops supplied in the direction A can move to the inner space 4.

At the other side a discharge chute 40 is positioned at the bottom, from which the cooled lollipops can be discharged from the inner space 4 in the direction D to be collected in a transport tray that is not further shown.

At the supply side two fans 10a, 10b are positioned next to to the supply chute 9. Upstream of the fans 10a, 10b there is an air filter 52. In the upper space 6 a condenser 50 and a heater 51 are positioned. In the upper part of the end space 7, in the transition of the upper space 6, a cooling space that is not further specified is situated, in which the circulating air (see arrow H, I, J) is cooled. The air channels 5, 6 and 7 are thus formed within the frame 2 by internal channels, as a result of which the device does not become too wide, which is advantageous in the set-up of several devices adjacent to each other. Because said channels are in fact limited by the insulated casing, condensation is prevented, which is of importance as in the area of use sugar substance is used, which with condensation might give rise to the formation of unwanted sticky masses. This might otherwise occur when free-lying tubes would be used for the cooling air movement. The use of the casing in the forming of channels according to the invention is cheap and gives rise to few problems in connection with cleaning.

In the inner space 4 five support plates 12a-e are positioned in the form of a marble alley. Said support plates 12a-e are further shown in the FIGS. 4A and 4B. Each support plate 12 has an upstream end 16 and a downstream end 17, and a bottom 13, side edges 18, end edge 19 at the upstream end 16, and two slanting walls 20, an end edge 21., and between the end edge 21 and the bottom 13 a drop opening 22, at the downstream end 17. The drop opening 22 is limited to either side by depending rubber partitions 23.

In the centre the support plates 12a-e are supported on respective cross bars 15a-e, which at the end are supported on rollers for movement in transverse direction. The cross bars 15a-e are furthermore connected to respective eccentrics on a vertical driving shaft 42 by means of ball-and-socket joint 40 and drive rods 41, which driving shaft is bearing mounted in bearings 31a,b and is rotated by motor 60 (see FIG. 1 and FIG. 4A). The eccentrics for the respective bars 15a-e are positioned offset one to the other at an angle (regularly divided over 360°), as a result of which imbalance is avoided as much as possible.

At the ends 16 and 17 the support plates are provided with support rollers 34 and 35 that are able to reciprocally move on the cross girders 33, which are attached to vertical posts 32 that are permanent to the frame 2 (FIG. 1, left: on the right hand side a comparable structure is present).

At the downstream end 17, the slanting walls 20 are provided with a longitudinal slit 24 near the upper surface of the bottom 13, which slit discharges into a chute 25.

The support plate 12, particularly its bottom 13, as can be seen in FIG. 5, is built up from a support layer 26 of resilient synthetic material, as well as situated underneath it and adhered to it, an aluminium honeycomb plate 27, having a core 28 of honeycomb cells and a lower cover plate 29 and an upper cover plate 30. Such a bottom is rigid against sagging and remains flat, also in case of larger spans. Moreover the bottom 13 is lightweight. The resilient synthetic material is resistant against cleaning agents and offers sufficient friction with respect to the lollipop to bring the lollipop in motion during the shaking movement, so that the lollipops do not tend to lie still. A suitable material to that end is None 2M1570 FDA, built up from an upper layer of 0.5 mm of PVC None 65 FDA blue and a lower layer of fabric impregnated with PURR Ronal blue, available from the firm Amoral.

In operation the lollipops provided with a stick are supplied in the direction A. Cooling air is circulated by the fans 10a and 10b, and flows in the direction E in the inner space 4, above the upstream end of the support plate 12a, underneath the upstream end of the support plate 12b and simultaneously above the downstream end of the support plate 12c, respectively underneath the upstream end of the support plate 12d and above the downstream end of the support plate 12e. The air flows are permitted to move downwards over the inclined wall members 20 in the direction F in order to also be able to flow over the surface of the support plates 12b and 12d.

In FIG. 1 it is shown that the air flows occur in the directions E, F and G and then subsequently exit at the supply end 5 in the direction H, flow upwards, through filter 52 to be propelled again by the fans 10a and 10b on either side along the supply chute 9, and then in the direction 1, through the upper space 6 and the condenser 50 and heater 51 placed in there, separated from the inner space 4 by the upper plate 14. The air bends downwards in the direction J to subsequently flow in the direction E in the inner space 4 again, over the plates 12a-e, to the space 5, all this as a result of the pressure difference between the spaces 7 and 5.

The stream of recently formed, still warm lollipops arrives from the directtin A, over the supply chute 9, and moves in the direction B over the support plate 12a. At the end of the support plate 12a the lollipops fall in the direction C through the opening 22, and arrive on the next support plate 12b. This is repeated a number of times, the lollipops on the support plates 12a, 12c, 12e being in counter flow with the cooling air, and on the support plates 12b and 12d being in flow therewith.

Finally the lollipops arrive at the downstream end of the lowermost support plate 12e to be discharged in the direction D, via the discharge chute 40.

As a result of the flatness of the bottoms 13 the lollipops remain nicely distributed during the movements over the various support plates 12a-e as a result of which the lollipops remain really round.

As a result of the slanting walls 20 and the slits 24 in there, a sideward reception and discharge means is provided for grit from the lollipops. This can be discharged in the direction K, L and M, via the chutes 25 and then into a tray that is not further shown. The height of the slits is smaller than the thickness of the lollipops' sticks, so that the lollipops remain entirely out of the slits 24.

The slits 24 can also be used in for instance sweeping the support plates 12 clean by means of a broom or sweeper in between the operation processes.

The movement of the grit towards the slits 24 is enhanced because the shaking motion of the support plates 12 is transverse to the conveyance direction B.

1. Cooling machine for lollipops, comprising at least one support plate having a support surface for supporting lollipops during cooling, means for generating a cooling air flow past the support surface and means for shaking the support surface, the plate being a honeycomb panel having a honeycomb core and an upper cover plate and a lower cover plate, the core being made of metal and the cover plates being fixedly adhered to the core and the upper cover plate forming the support surface directly or not.

2. Cooling machine according to claim 1, the honeycomb core and the cover plates being made of aluminium.

3. Cooling machine according to claim 1, the upper cover plate being coated with a layer of resilient synthetic material having a water repellent, cleansing means resistant closed surface.

4. Cooling machine according to claim 3, the layer of resilient synthetic material consisting of a material with sufficient friction with respect to the lollipop in order to bring the lollipop in motion during the shaking motion of the support surface.

5. Cooling machine according to claim 3, the layer of resilient synthetic material over its entire surface being adhered to the upper cover plate.

6. Cooling machine according to claim 1, comprising a supply for the lollipops and a discharge for the lollipops and a number of support plates positioned in between them inclined from the supply to the discharge, consecutive support plates being inclined in opposite directions.

7. Cooling machine according to claim 6, the shaking means being adjusted for shaking the support plates in transverse direction to the inclination.

8. Cooling machine according to claim 6, the shaking means being adapted for shaking consecutive support plates simultaneously in a regular out-of-phase manner.

9. Cooling machine according to claim 6, the support plates in side view defining a vertical zig-zag shape, the supply being situated at the top.

10. Cooling machine according to claim 9, the number of support plates being odd and the discharge being situated at the side of the cooling machine that is opposite the supply.

11. Cooling machine according to claim 10, The support surfaces having a longitudinal direction of extension, the cooling means comprising cooling air flow generators, positioned in a cooling air circuit in which the support surfaces are included, as seen in their longitudinal direction of extension.

12. Cooling machine according to claim 11, comprising a supply end and a discharge end, the cooling air circuit comprising the supply end, the discharge end and a horizontal return channel which is situated above over the upper support plate, a separation plate being arranged in between the return channel and the upper support plate.

13. Cooling machine according to claim 12, the cooling means comprising propelling means that are placed at the supply end.

14. Cooling machine according to claim 13, the propelling means being placed at the top and converting the flow of the air from a vertical direction into a horizontal direction.

15. Cooling machine according to claim 12, the propelling means being fans.

16. Cooling machine according to claim 12, the supply being narrower than the support plate consecutive to it.

17. Cooling machine according to claim 6, the support plates being inclined from a respective upper end to a respective lower end, baffles being arranged at the lower end of each inclined support plate at either side of the lower or discharge end thereof, which baffles are provided with slits situated parallel to the support surface, the height of the slits being smaller than the thickness of the sticks of the lollipops.

18. Cooling machine according to claim 17, the baffles being inclined with respect to the direction of inclination, considered in top view.

19. Cooling machine according to claim 17, further provided with grit reception means behind the slits in the baffles.
